(19) United States
(12) Patent Application Publication
(10) Pub. No.: US 2014/0316651 A1
(43) Pub. Date: Oct. 23, 2014

(54) VEHICLE HAVING AN AUXILIARY BATTERY

(71) Applicant: SANG IK CHO, Suwan-si, Gyeonggi-do, Gyeonggi-do (KR)

(72) Inventor: Sang Ik Cho, Gyeonggi-do (KR)

(73) Assignee: LEADER TECH CO., LTD, INCHEON-SI (KR)

(21) Appl. No.: 14/363,978

(22) PCT Filed: Dec. 10, 2012
(86) PCT No.: PCT/KR2012/010707

§ 371 Date: Jun. 9, 2014

(30) Foreign Application Priority Data
Dec. 8, 2011 (KR) 10-2011-0131381

(51) Int. Cl. B60L 1/02

(52) U.S. Cl. CPC B60L 1/02
USPC 701/36

(57) ABSTRACT

The present invention relates to a vehicle comprising: a third control unit for sensing the gear being placed into a parking mode and the removal of an ignition key; a control unit including a temperature-setting part for setting a temperature for a cooling or heating operation, a second sensor for sensing whether or not an indoor temperature has reached the temperature for the cooling or heating operation, a selection switch for enabling a user to select a cooling mode or a heating mode, and an operating switch for operating a cooler or a heater in accordance with the selected cooling mode or heating mode; a main battery for storing power generated by a generator; a first auxiliary battery and a second auxiliary battery for storing surplus power of the main battery; a first control unit interconnected between the main battery and the first and second auxiliary batteries so as to selectively supply the surplus power of the main battery to the less-charged side of either the first auxiliary battery and the second auxiliary battery; a second control unit interconnected between the output ends of the first and second auxiliary batteries and the cooler and the heater so as to selectively supply the charged power of the first and second auxiliary batteries to the cooler and the heater; an air-circulating device connected to one end of the second control unit so as to be operated by the driving power of the first and second auxiliary batteries; a carbon dioxide sensor connected to the other end of the second control unit so as to sense the concentration of carbon dioxide in an indoor area of the vehicle; and a converting switch interconnected between the first control unit and the second control unit so as to supply the power of the first and second auxiliary batteries to a starter motor upon the occurrence of a discharge of the main battery.

### CROSS-REFERENCE TO RELATED APPLICATIONS

This application is a National phase of PCT patent Application No. PCT/KR2012/010707 having International filing date of Dec. 10, 2012 which claims the benefit of priority of Korean Patent Application No. 10-2011-0131381 filed on Dec. 8, 2011. The contents of the above applications are all incorporated by reference as if fully set forth herein in their entirety.

### TECHNICAL FIELD

The present invention relates to a vehicle having an auxiliary battery, and more particularly, to a vehicle having an auxiliary battery that can smoothly operate an air conditioner or a heater in an engine stop state or while traveling by additionally installing at least two auxiliary batteries that can store surplus power of a main battery.

### BACKGROUND ART

In general, an electric system of a vehicle receives rotatory power of an engine, converts the rotatory power to electrical energy in a generator, stores the electrical energy at a battery, and uses the electrical energy as power for a light and a radio of the vehicle.

In such a conventional electric system of a vehicle, only one battery is provided, and thus when charge of the battery is complete, surplus power is generally wasted by emitting, and particularly, in a summer season and a winter season, after the vehicle is stopped, when a conditioner or a heater is not driven, an indoor temperature of the vehicle becomes a high temperature or a low temperature and thus a person cannot stay within the vehicle.

Therefore, by operating again an engine, the air conditioner or the heater should be operated and thus even when the vehicle is not traveled, fuel is consumed and thus there is a problem that resource waste and environment contamination occur.

In order to solve the above problem, in Korean Patent No. 974182 (registered date: Jan. 7, 2008) applied by the present applicant, by additionally installing an auxiliary battery in addition to a main battery and by charging surplus power of the main battery at the auxiliary battery, even when an engine is stopped, by operating an air conditioner or a heater using surplus power charged at the auxiliary battery, use convenience is enhanced and a resource is saved, and release of an environment contamination material is reduced.

As described above, at the prior art applied by the present applicant and already registered, as only one auxiliary battery exists, and in a state in which an engine is stopped, a time that can operate an air conditioner or a heater is relatively short and thus while travelling a vehicle, a condition that cannot operate the air conditioner or the heater occurs and thus an original purpose that operates the air conditioner and the heater with surplus power of the main battery may not be achieved.

### DETAILED DESCRIPTION OF INVENTION

### Technical Problem

The present invention has been made in view of the above problems, and provides a vehicle having an auxiliary battery that can smoothly operate an air conditioner or a heater for a long time in an engine stop state by additionally installing at least two auxiliary batteries that can store surplus power of a main battery and that can operate an air conditioner or a heater with an auxiliary battery while travelling and that can charge from a battery having a lower charge amount by checking a charge voltage of at least two auxiliary batteries and that can start the vehicle by at least two auxiliary batteries by manipulation of a conversion switch, particularly when starting is not performed due to discharge of the main battery and that can thus perform stable starting of the vehicle even when the main battery is completely discharged.

The present invention further provides a vehicle having an auxiliary battery that can previously prevent a death accident by measuring concentration of carbon dioxide within the vehicle and by operating an air circulation device, and by measuring an indoor temperature and an outdoor temperature of the vehicle before sleep and by enabling an indoor temperature of the vehicle and an outdoor air temperature to maintain a constant temperature difference after a predetermined time, when a mode of a vehicle is converted to a sleep mode that can sleep within the vehicle.

### Technical Solution

In accordance with an aspect of the present invention, a vehicle having an auxiliary battery; controllers including a third controller that detects a parking mode of a gear and removal of an ignition key, a temperature setting unit that sets an air conditioning or heating temperature, a second sensor that detects whether an indoor temperature arrives at an operation temperature, a selection switch that enables a user to select an air conditioning mode or a heating mode, and an operation switch that drives an air conditioner and a heater according to the selected air conditioning or heating mode; and a main battery that charges generation power of the generator includes: first and second auxiliary batteries that store surplus power of the main battery; a first controller connected between the main battery and the first and second auxiliary batteries to selectively supply surplus power of the main battery to the battery having a lower charge amount in the first and second auxiliary batteries; a second controller connected between an output terminal of the first and second auxiliary batteries and the air conditioner and the heater to selectively supply charge power of the first and second auxiliary batteries to the air conditioner and the heater; an air circulation device connected to one side terminal of the second controller to operate by driving power of the first and second auxiliary batteries; a carbon dioxide detection sensor connected to the other side terminal of the second controller to detect concentration of carbon dioxide within a vehicle room; and a conversion switch connected between the first controller and the second controller to supply power of the first and second auxiliary batteries to a starter motor when the main battery is discharged.

Preferably, the air conditioner and the heater are driven by the first or second auxiliary batteries, when starting is in a turn on state by detection of the third controller, and the air conditioner and the heater are driven by the main battery, when starting is in a turn off state by detection of the third controller.

Preferably, the controllers include a sleep mode setting unit that sets a condition for sleeping within the vehicle room.

### Advantageous Effects

According to the present invention, by additionally installing at least two auxiliary batteries that can store surplus power of a main battery installed in a vehicle, in an engine stop state and while traveling, an air conditioner or a heater can be smoothly operated for a long time, and by checking a charge voltage of at least two auxiliary batteries, charging is performed from a battery having a lower charge amount, and when starting is not performed due to discharge of the main battery, by performing temporary starting of the vehicle by at least two auxiliary batteries by manipulation of a conversion switch, even when the main battery is completely discharged, stable starting of the vehicle can be performed.

According to the present invention, when a mode of a vehicle is converted to a sleep mode that can sleep within a vehicle room, by measuring an outdoor temperature and an indoor temperature of the vehicle before sleep and by enabling an outdoor air temperature and an indoor temperature of the vehicle to maintain an ideal temperature difference for sleep after a predetermined time, and by measuring concentration of carbon dioxide within the vehicle room and by operating an air circulation device, a death accident that may occur when a person sleeps in a state in which a window of the vehicle is closed can be previously prevented.

### BRIEF DESCRIPTION OF DRAWINGS

FIG. 1 is a block diagram illustrating a configuration of a vehicle having an auxiliary battery according to an exemplary embodiment of the present invention;

FIG. 2a is a flowchart illustrating power supply of an air conditioner and a heater according to a starting state and a charging process according to a state of an auxiliary battery in a vehicle having an auxiliary battery according to an exemplary embodiment of the present invention; and

FIG. 2b is a flowchart illustrating operation in a sleep mode in a vehicle having an auxiliary battery according to an exemplary embodiment of the present invention.

### BEST MODES FOR CARRYING OUT THE INVENTION

In the present invention, a vehicle having an auxiliary battery; controllers including a third controller that detects a parking mode of a gear and removal of an ignition key, a temperature setting unit that sets an air conditioning or heating temperature, a second sensor that detects whether an indoor temperature arrives at an operation temperature, a selection switch that enables a user to select an air conditioning mode or a heating mode, and an operation switch that drives an air conditioner and a heater according to the selected air conditioning or heating mode; and a main battery that charges generation power of the generator includes: first and second auxiliary batteries that store surplus power of the main battery; a first controller connected between the main battery and the first and second auxiliary batteries to selectively supply surplus power of the main battery to the battery having a lower charge amount in the first and second auxiliary batteries; a second controller connected between an output terminal of the first and second auxiliary batteries and the air conditioner and the heater to selectively supply charge power of the first and second auxiliary batteries to the air conditioner and the heater; an air circulation device connected to one side terminal of the second controller to operate by driving power of the first and second auxiliary batteries; a carbon dioxide detection sensor connected to the other side terminal of the second controller to detect concentration of carbon dioxide within a vehicle room; and a conversion switch connected between the first controller and the second controller to supply power of the first and second auxiliary batteries to a starter motor when the main battery is discharged.

### Mode for Carrying Out the Invention

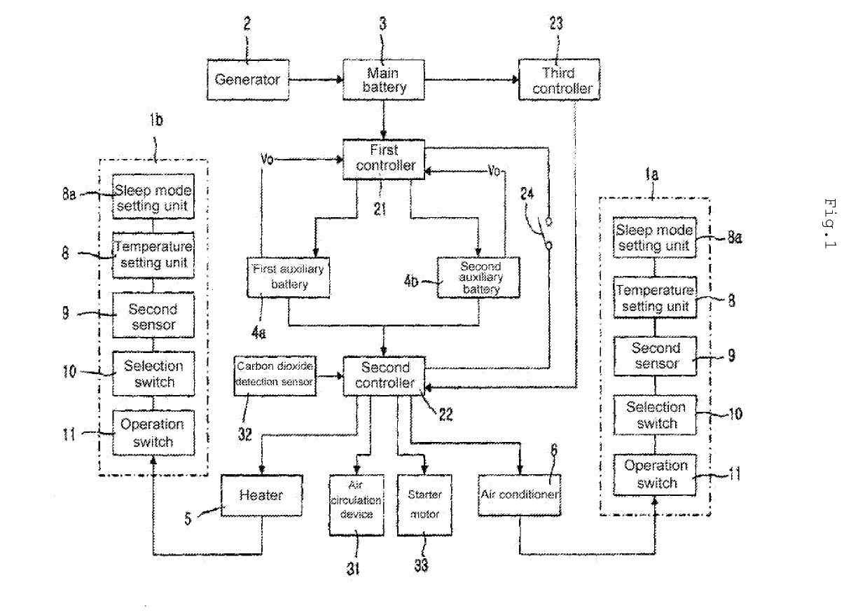

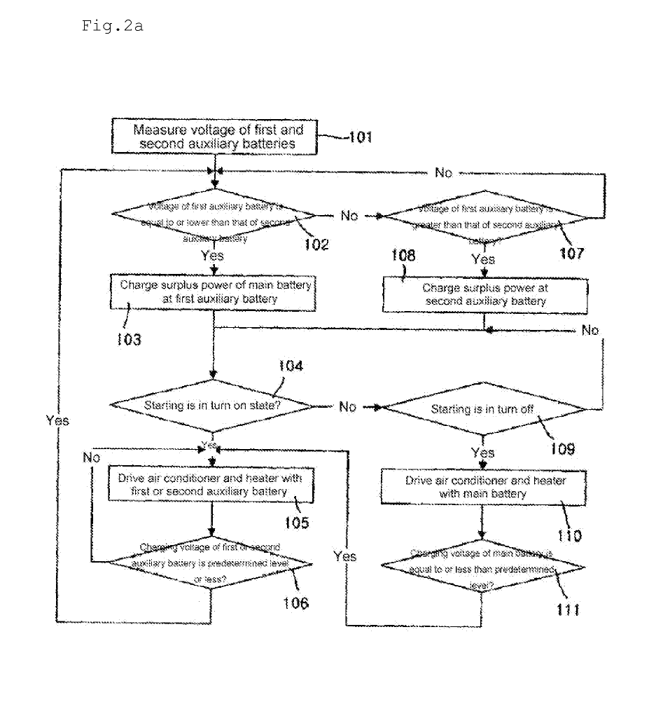

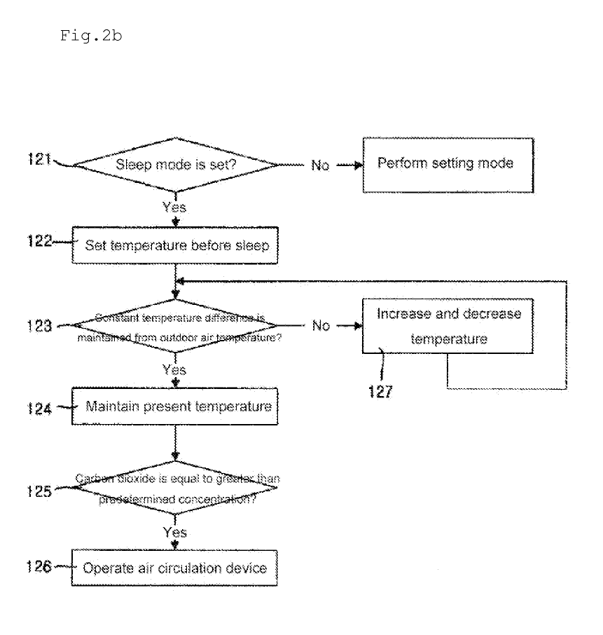

Hereinafter, a vehicle having an auxiliary battery according to an exemplary embodiment of the present invention will be described with reference to FIGS. 1 and 2.

FIG. 1 is a block diagram illustrating a configuration of a vehicle having an auxiliary battery according to an exemplary embodiment of the present invention, and in the vehicle, a main battery 3 that stores power generated in a generator 2 and first and second auxiliary batteries 4a and 4b that store surplus power of the main battery 3 are provided, and a first controller 21 that measures a voltage Vo of the first and second auxiliary batteries 4a and 4b and that selectively supplies surplus power of the main battery 3 to the battery having a lower charge amount is connected between the main battery 3 and the first and second auxiliary batteries 4a and 4b.

Further, a second controller 22 for selectively supplying charge power of the first and second auxiliary batteries 4a and 4b to an air conditioner 6 and a heater 5 is connected between an output terminal of the first and second auxiliary batteries 4a and 4b and the air conditioner 6 and the heater 5, an air circulation device 31 that operates by driving power of the first and second auxiliary batteries 4a and 4b is connected to one side terminal of the second controller 22, and a carbon dioxide detection sensor 32 that detects concentration of carbon dioxide within a vehicle room and that drives the air circulation device 31 is connected to the other side terminal of the second controller 22.

A third controller 23 that detects a parking mode of a gear and removal of an ignition key is connected between the main battery 3 and the second controller 22, and a conversion switch 24 that can temporarily start by an auxiliary battery when the main battery 3 is discharged is connected between the first controller 21 and the second controller 22.

At one side of the air conditioner 6, controllers 1a and 1b including a temperature setting unit 8 that sets a cooling and heating temperature, a second sensor 9 that detects whether an indoor temperature arrives at an operation temperature, a selection switch 10 that enables a user to select an air conditioning mode or a heating mode, an operation switch 11 that turns on/off the air conditioner 6 and the heater 5 according to the selected air conditioning or heating mode, and a sleep mode setting unit 8a that sets a condition to sleep within the vehicle room are connected.

The third controller 23 detects a parking mode of a gear and removal of an ignition key, drives the air conditioner 6 and the heater 5 first using the main battery 3 when starting of the vehicle is turned off, and transmits and receives data to and from the second controller 22 so as to use the auxiliary batteries 4a and 4b.

The temperature setting unit 8 sets an operation temperature that automatically perform air conditioning or heating, and when an indoor temperature is 27° C. or more, air conditioning is generally performed, and when an indoor temperature is 15° C. or less, heating is generally performed.

The second sensor 9 detects an indoor temperature randomly set by a user, and when the indoor temperature is greater than or equal to a setting temperature, the second sensor 9 turns on the operation switch 11.

By previously setting air conditioning or heating, the selection switch 10 may perform air conditioning in a summer season and perform heating in a winter season.

The operation switch 11 turns on/off the air conditioner 6 or the heater 5 according to the selected mode, and an “operation preparation time point” of the operation switch 11 is set by a driver, and in a state in which operation preparation is complete, the operation switch 11 receives a signal of the second sensor 9 and turns on/off the air conditioner 6 and the heater 5.

The carbon dioxide detection sensor 32 detects concentration of carbon dioxide within the vehicle room, and when concentration of carbon dioxide is greater than or equal to a predetermined concentration, by driving the air circulation device 31, the carbon dioxide detection sensor 32 previously prevents a death accident that may occur when a person sleeps in a state in which a window of the vehicle is closed.

The sleep mode setting unit 8a determines a condition for optimizing an indoor temperature of the vehicle in a state in which a window of the vehicle is closed.

An operation process of a vehicle having an auxiliary battery according to an exemplary embodiment of the present invention having the foregoing configuration will be described in detail.

FIG. 2A is a flowchart illustrating power supply of an air conditioner and a heater according to a starting state and a charging process according to a state of an auxiliary battery in a vehicle having an auxiliary battery according to an exemplary embodiment of the present invention, and the first controller 21 measures a voltage Vo of the first and second auxiliary batteries 4a and 4b (step 101) and detects a battery having a lower output voltage.

The first controller 21 determines whether an output voltage of the first auxiliary battery 4a is lower than or equal to that of the second auxiliary battery 4b (step 102), and if an output voltage of the first auxiliary battery 4a is lower than or equal to that of the second auxiliary battery 4b, by connecting the main battery 3 and the first auxiliary battery 4a, the first controller 21 charges surplus power of the main battery 3 at the first auxiliary battery 4a (step 103).

If an output voltage of the first auxiliary battery 4a is greater than that of the second auxiliary battery 4b (step 107), by connecting the main battery 3 and the first auxiliary battery 4a, the first controller 21 charges surplus power of the main battery 3 at the second auxiliary battery 4b (step 108).

Further, the first controller 21 determines whether starting is in a turn on state (step 104), and if starting is in a turn on state, the second controller 22 drives the air conditioner 6 and the heater 5 using the first auxiliary battery 4a or the second auxiliary battery 4b (step 105), and the second controller 22 determines whether a charging voltage of the first auxiliary battery 4a or the second auxiliary battery 4b is equal to or less than a predetermined level (step 106), and if a charging voltage of the first auxiliary battery 4a or the second auxiliary battery 4b is equal to or less than a predetermined level, the process returns to step 102.

In this way, when starting is in a turn on state, if the air conditioner 6 and the heater 5 are driven, the air conditioner 6 and the heater 5 use the remaining battery other than a battery charged by the generator 2, and when the air conditioner 6 and the heater 5 are driven, if a using battery is discharged, a charging battery is used instead of the using battery and the discharged battery is charged by the generator 2.

The third controller 23 determines whether starting is in a turn off state (step 109), and if starting is in a turn off state, the first and second controllers 21 and 22 drive the air conditioner 6 and the heater 5 with the main battery 3 (step 110), and the first and second controllers 21 and 22 determine whether a charging voltage of the main battery 3 is equal to or less than a predetermined level (step 111), and if a charging voltage of the main battery 3 is equal to or less than a predetermined level, the process returns to step 105 and the first and second controllers 21 and 22 drive the air conditioner 6 and the heater 5 with the first and second auxiliary batteries 4a and 4b.

Therefore, two auxiliary batteries 4a and 4b that can store surplus power of the main battery 3 are additionally installed, and in an engine stop state, the two auxiliary batteries 4a and 4b can smoothly operate the air conditioner and the heater for a long time.

As the main battery 3 is completely discharged, when starting is not performed, if the conversion switch 24 is connected to a turn on contact point by the driver's manipulation, a control signal of complete discharge of the main battery 3 is transmitted from the first controller 21 to the second controller 22, and thus the second controller 22 supplies power of the first and second auxiliary batteries 4a and 4b to the starter motor 33 and thus as starting is temporarily performed by the first and second auxiliary batteries 4a and 4b, even when the main battery 3 is completely discharged, stable starting may be performed.

FIG. 2B is a flowchart illustrating operation in a sleep mode in a vehicle having an auxiliary battery according to an exemplary embodiment of the present invention, and when the sleep mode setting unit 8a of the controllers 1a and 1b is selected, a temperature and air are circulated so that a person sleeps within the vehicle room.

That is, the controllers 1a and 1b determine whether the vehicle is in a sleep mode (step 121) by manipulation of the sleep mode setting unit 8a by the driver, and if the vehicle is in a sleep mode, by manipulating the temperature setting unit 8, the controllers 1a and 1b set a temperature before sleep (step 122), and by driving the air conditioner 6 and the heater 5, an indoor temperature of the vehicle increases or decreases.

In such a state, after a predetermined time has elapsed, the controllers 1a and 1b determine whether a vehicle indoor temperature and an outdoor air temperature maintain a constant temperature difference (step 123), and if a vehicle indoor temperature and an outdoor air temperature maintain a constant temperature difference, the controllers 1a and 1b recognize that the condition is an optimal sleep condition and maintains a present temperature (step 124), and if a vehicle indoor temperature and an outdoor air temperature does not maintain a constant temperature difference, by continuously driving the air conditioner 6 and the heater 5, the vehicle indoor temperature increases and decreases.

In this case, the second controller 22 detects concentration of carbon dioxide of the vehicle room using the carbon dioxide detection sensor 32 and determines whether the detected concentration of carbon dioxide is equal to or greater than a predetermined concentration (step 125), and if the detected concentration of carbon dioxide is equal or greater than a predetermined concentration, the second controller 22 drives the air circulation device 31 and circulates indoor air of the vehicle (step 126).

Therefore, when a mode of the vehicle is converted to a sleep mode that can sleep within the vehicle room, by measuring an indoor temperature of the vehicle and an outdoor temperature before sleep and by enabling the indoor temperature of the vehicle and an outdoor air temperature to maintain a most ideal temperature difference for sleep after a predetermined time, and by measuring concentration of carbon dioxide of the vehicle room and by operating an air circulation device, a death accident may occur when a person sleeps in a state in which a window of the vehicle is closed can be previously prevented.

1. A vehicle having an auxiliary battery; controllers 1a and 1b comprising a third controller 23 that detects a parking mode of a gear and removal of an ignition key, a temperature setting unit 8 that sets an air conditioning or heating temperature, a second sensor 9 that detects whether an indoor temperature arrives at an operation temperature, a selection switch 10 that enables a user to select an air conditioning mode or a heating mode, and an operation switch 11 that drives an air conditioner 6 and a heater 5 according to the selected air conditioning or heating mode; and a main battery 3 that charges generation power of the generator 2, the vehicle comprising:
first and second auxiliary batteries 4a and 4b that store surplus power of the main battery 3;
a first controller 21 connected between the main battery 3 and the first and second auxiliary batteries 4a and 4b to selectively supply surplus power of the main battery 3 to the battery having a lower charge amount in the first and second auxiliary batteries 4a and 4b;
a second controller 22 connected between an output terminal of the first and second auxiliary batteries 4a and 4b and the air conditioner 6 and the heater 5 to selectively supply charge power of the first and second auxiliary batteries 4a and 4b to the air conditioner 6 and the heater 5;
an air circulation device 31 connected to one side terminal of the second controller 22 to operate by driving power of the first and second auxiliary batteries 4a and 4b;
a carbon dioxide detection sensor 32 connected to the other side terminal of the second controller 22 to detect concentration of carbon dioxide within a vehicle room; and
a conversion switch 24 connected between the first controller 21 and the second controller 22 to supply power of the first and second auxiliary batteries 4a and 4b to a starter motor 33 when the main battery 3 is discharged.

2. The vehicle of claim 1, wherein the air conditioner 6 and the heater 5 are driven by the first or second auxiliary batteries 4a and 4b, when starting is in a turn on state by detection of the third controller 23, and the air conditioner 6 and the heater 5 are driven by the main battery 3, when starting is in a turn off state by detection of the third controller 23.

3. The vehicle of claim 1, wherein the controllers 1a and 1b comprise a sleep mode setting unit 8a that sets a condition for sleeping within the vehicle room.
